(19) United States
(12) Patent Application Publication
(10) Pub. No.: US 2003/0097973 A1
(43) Pub. Date: May 29, 2003

(54) Decorative apparatus for driving away burrowing varmints

(76) Inventor: Gregory E. Fremstad, Cheshire, OR (US)

Correspondence Address: MARGER JOHNSON & MCCOLLOM PC, 1030 SW MORRISON STREET, PORTLAND, OR, 97205, US

(21) Appl. No.: 09/998,539

(22) Filed: Nov. 29, 2001

(51) Int. Cl. A01M 29/00

(52) U.S. Cl. 116/22 A

(57) ABSTRACT

A burrowing animal repellant apparatus transmits a physical vibration to the ground, by means of a percussive device and preferably responsive to ambient wind. The percussive device is responsive to low-velocity ambient wind and is enabled irrespective of wind direction. The apparatus can be produced in decorative shapes.

A percussive device comprises a rod and a helical annulus, having a helical surface, coaxial to the rod. A hammer has a foot disposed to move upward along the helical surface in response to rotational energy provided by a wind vane. Descent of the foot from the upper end of the helical annulus to its lower end creates a physical vibration, which is transmitted into the ground through the rod.

An alternative percussive device comprises a rod protrusion and a contact surface positioned to be contacted by the protrusion during rod rotation. Contact during rod rotation produces thereby a physical vibration.

### BACKGROUND OF THE INVENTION

The present invention is related to the field of control of moles and other burrowing animals, and more specifically to vibratory devices for imparting sound waves to the ground to deter burrowing rodents, such as gophers and moles. It is generally known that the transmission of physical vibrations to the ground can repel burrowing rodents.

### SUMMARY OF THE INVENTION

The burrowing animal repellant apparatus of the present invention transmits a physical vibration to the ground. The physical vibration is created by a percussive device, preferably responsive to ambient wind. The percussive device of the present invention produces very little drag or frictional resistance to the wind vane. The device is thereby responsive to low-velocity ambient wind. Further, rotation is enabled irrespective of wind direction. The apparatus can be produced in decorative shapes.

Generally, a first embodiment of the percussive device comprises a rod. A helical annulus is positioned concentric with and coaxial to the rod. The annulus includes a surface describing a helical path. A hammer is provided, having a foot disposed to slide on the helical surface. Means are provided for moving said foot along the helical surface in response to rotational energy. Movement of the foot along the helical surface causes the hammer to drop from an upper point on the helical surface to a lower point on same.

A second embodiment of the percussive device replaces the helical annulus and hammer with a protrusion extended from the rod and substantially orthogonal to the longitudinal axis of the rod. A contact surface is positioned so as to be contacted by the protrusion during a rotation of the rod. Rotation of the rod causes the protrusion to contact the strike surface at least one time. The contact produces a vibration.

A burrowing animal repellant apparatus according to the present invention comprises a support rod having a longitudinal axis and adapted to be inserted into the ground, and a wind vane adapted to rotate about the longitudinal axis of the rod in response to ambient wind. A percussive device is provided, adapted to generate a vibration in response to rotational energy. The preferred rotational energy is ambient wind, although other energy forms can be utilized. Rotation of the wind vane drives the percussive device, generating a physical vibration resulting thereby and transmitting same through the rod and into the ground.

The invention will become more readily apparent from the following Detailed Description, which proceeds with reference to the drawings, in which:

### BRIEF DESCRIPTION OF THE DRAWINGS

FIG. 1 is a perspective view of one embodiment of a burrowing animal repellant apparatus according to the present invention.

FIG. 2 is an enlarged side view of the of the apparatus shown in FIG. 1, showing a vane element and a percussive device embodiment.

FIG. 3 is bottom plan view of the vane element of the apparatus shown in FIG. 1.

FIG. 4 is an enlarged side view of the percussive device embodiment shown in FIG. 2.

FIG. 5 is an enlarged, partial cross-sectional side view of a vane element and a second embodiment of a percussive device incorporated into another burrowing animal repellant apparatus according to the present invention.

FIGS. 6A and 6B are perspective and plan views, respectively, of one aspect of the percussive device shown in FIG. 5.

### DETAILED DESCRIPTION OF PREFERRED EMBODIMENTS

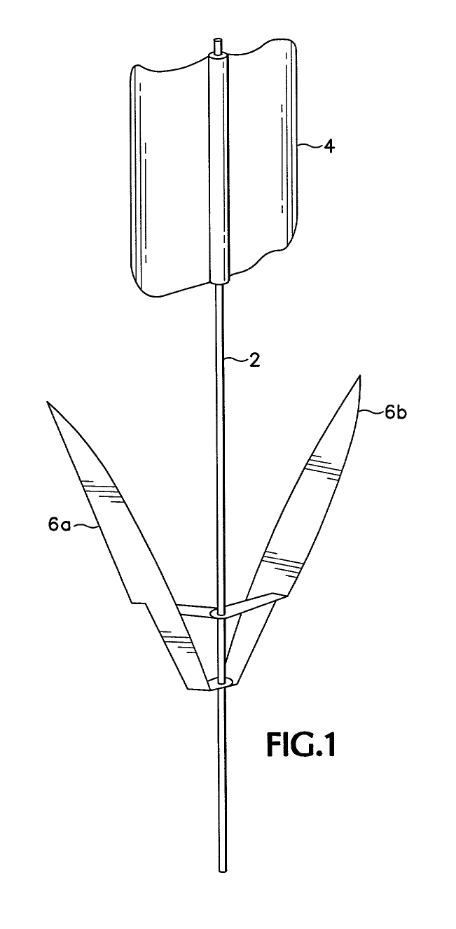

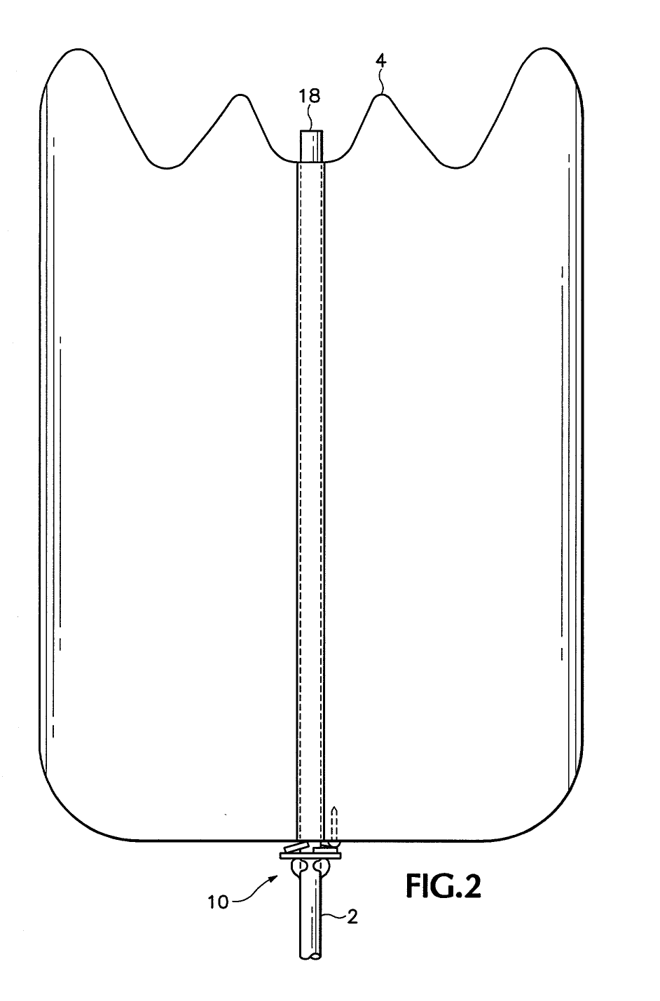

As has been mentioned, the present invention provides a percussive device and a burrowing animal repellant apparatus employing the percussive device. Turning now to FIGS. 1 and 2, a representative embodiment of an apparatus according to the present invention is shown. The apparatus comprises a rod 2, adapted to be embedded substantially vertically into the ground. Wind vane 4 is provided and rotatably coupled to the rod 2, with a cap 18 retaining the wind vane on the rod. A percussive device 10 is provided, operation of which is discussed below.

The wind vane can be manufactured in a variety of decorative shapes; a tulip or flower shape is shown in FIG. 1. Additional decorative elements such as leaves 6a,6b can be further provided. The leaves are not essential to the function of the apparatus described. In the embodiment of the apparatus shown, the percussive device is positioned at the lower portion of the wind vane.

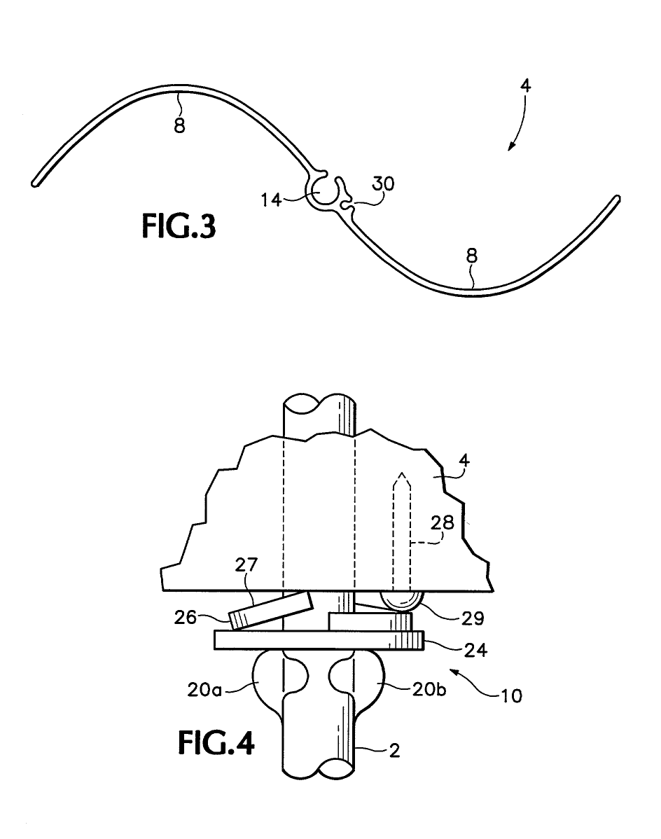

A cross-section through the wind vane is shown in FIG. 3. The vane 4 typically comprises two vane halves 8a,8b, but other configurations are possible. The vane halves are concave, with the concavities facing in substantially opposite directions. Opposing concavities enable the wind vane to respond to ambient wind, irrespective of the direction from which the wind approaches the wind vane. A slot or channel 14 in the wind vane rotatably accepts the rod 2.

A percussive device of the embodiment described above is shown generally in FIG. 2 and in greater detail in FIG. 4. The device comprises support means 20a, 20b in the rod 2. The support means are shown as deformities. The support means serve as a platform for positioning along the rod a support member, shown as a flat washer 24. The support member supports a helical annulus 26 having an upper helical surface 27, which extends around the rod approximately 360°. A hammer 28 is provided within the lower edge of the wind vane 4. The hammer 28 has a foot 29, which rests upon the upper helical surface of the helical annulus. The hammer is coupled to the wind vane via a second slot or channel 30 in FIG. 3, although other coupling means can be contemplated.

The exemplary hammer 28 shown is a round-head brad. In selecting alternative hammer materials or shapes, the objectives to be considered include low friction and sufficient hardness and durability to effectively and repetitively generate physical vibration for transmission through the rod 2 and into the ground.

Operation of the embodiment of the apparatus thus described is as follows. The wind vane 4 and hammer 28 rotate about the rod 2 in response to an input energy. The preferred input energy is ambient wind, which is captured by the halves 8a,8b of the wind vane 4 and translated into rotational energy. As the rod rotates, the foot 29 of the hammer moves upward along the helical surface of the annulus. Upon reaching the upper end of the helical annulus, the foot drops to a point near the lower end of the annulus. The impact of the foot of the hammer upon the helical annulus imparts a physical vibration through the annulus and into the rod coupled thereto. The physical vibration is then conducted along the rod and into the ground.

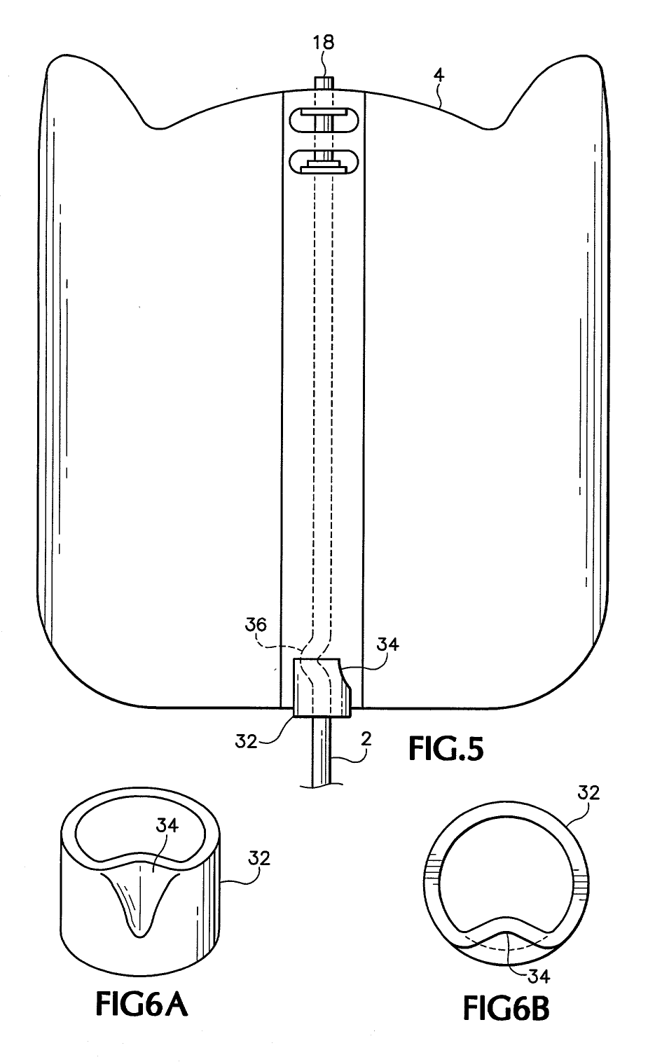

An alternative percussive device is shown in FIGS. 5, 6A and 6B. The operative elements of this embodiment comprise a strike surface 34, and a protrusion 36 on the rod 2. The embodiment of the percussive device is illustrated in a burrowing animal repellant apparatus. The strike surface, as shown, is a notched aspect in a collar 32 coupled to a wind vane 4, although other structures can be employed.

The collar 32 and rod 2 are positioned coaxially, with the portion of the rod 2 comprising the protrusion 36 residing within the collar 32. The collar is sized such that the rod can freely rotate within it, but that the protrusion 36 cannot freely rotate without contacting the strike surface 34 of the collar.

This embodiment of the apparatus of the present invention similarly operates in response to input rotational energy, and the preferred input energy is ambient wind. Wind is captured by the wind vane 4 and converted to rotational energy. As the wind vane 4 rotates, the collar 32 rotates. In the embodiment shown, the notched strike surface 34 will contact the protrusion 36 on the rod once per revolution of the wind vane. Contact between the protrusion and the strike surface creates a physical vibration, which is transmitted along the rod and into the ground.

A second strike surface (not shown) can be added opposite the first strike surface 34. First and second strike surfaces alternatively can be separated by less than 180°, to produce an irregular pattern of physical vibrations when the apparatus is in operation.

A person skilled in the art will be able to practice the present invention in view of the description present in this document, which is to be taken as a whole. While the invention has been disclosed in its preferred form, the specific embodiments thereof as disclosed and illustrated herein are not to be considered in a limiting sense. Indeed, it should be readily apparent to those skilled in the art in view of the present description that the invention can be modified in numerous ways. The inventor regards the subject matter of the invention to include all combinations and subcombinations of the various elements, features, functions and/or properties disclosed herein.

The invention claimed is:

1. A percussive device, comprising:
a rod having a longitudinal axis;
a helical annulus concentric with the rod, the annulus comprising:
a longitudinal axis, said axis being coaxial with said rod; and
a helical surface;
a hammer having a foot disposed to slide on the helical surface; and
means for moving said foot along the helical surface;
wherein movement of the foot along the helical surface causes hammer means to drop from an upper point on said helical surface to a lower point on same.

2. The device of claim 1, further comprising a wind vane coupled to the rod and adapted to rotate about a vertical axis in response to rotational energy.

3. The device of claim 2, wherein the vane is adapted to rotate uni-directionally irrespective of wind direction.

4. The device of claim 2, wherein the vane is shaped to blend into surrounding flora.

5. The device of claim 1, wherein the helical annulus is coupled to the rod.

6. The device of claim 1, wherein the hammer is coupled to the rod.

7. A percussive device, comprising:
a rod having a longitudinal axis;
a protrusion extended from the rod and substantially orthogonal to the longitudinal axis of the rod; and
a contact surface adapted to rotate about said longitudinal axis in response to applied rotational energy and positioned so as to be contacted by the protrusion during said rotation;
wherein rotation of the contact surface causes the contact surface to strike the protrusion at least one time.

8. The device of claim 7, further comprising a second protrusion extended from the rod the rod and substantially orthogonal to the longitudinal axis of the rod, said protrusion positioned so as to strike a contact surface during a rotation of the rod.

9. The device of claim 7, further comprising a second contact surface positioned so as to be contacted by a protrusion during a rotation of the rod.

10. A burrowing animal repellant apparatus, comprising:
a support rod having a longitudinal axis and adapted to be inserted into the ground;
a wind vane adapted to rotate about the longitudinal axis of the rod in response to ambient wind;
a helical annulus concentric with the rod, the annulus comprising:
a longitudinal axis, said axis being coaxial with said rod; and
a helical surface;
a hammer having a foot disposed to slide on the helical surface; and
means for moving said foot along the helical surface in response to rotational energy;
wherein movement of the foot along the helical surface causes hammer means to drop from an upper point on said helical surface to a lower point on same, a vibration resulting thereby being transmitted from the helical surface through the rod and into the ground.

11. The device of claim 10, wherein the vane is adapted to rotate uni-directionally irrespective of wind direction.

12. The device of claim 10, wherein the vane is shaped to blend into surrounding flora.

13. The device of claim 10, wherein the helical annulus is coupled to the rod.

14. The device of claim 10, wherein the hammer is coupled to the rod.

15. A burrowing animal repellant apparatus, comprising:
a support rod having a longitudinal axis and adapted to be inserted into the ground, said rod having a longitudinal axis;
a protrusion coupled to the rod and substantially orthogonal to the longitudinal axis of the rod;
a contact surface positioned so as to be contacted by the protrusion during a rotation of the rod; and
a wind vane coupled to said rod and adapted to rotate about a vertical axis in response to ambient wind;
wherein rotation of the rod causes the protrusion to strike the strike surface at least one time a vibration resulting thereby being transmitted from the helical surface through the rod and into the ground.

16. The device of claim 15, wherein the wind vane is adapted to rotate uni-directionally irrespective of wind direction.

17. The device of claim 15, wherein the wind vane is shaped to blend into surrounding flora.

18. The device of claim 15, further comprising a second protrusion extended from the rod the rod and substantially orthogonal to the longitudinal axis of the rod, said protrusion positioned so as to strike a contact surface during a rotation of the rod.

19. The device of claim 15, further comprising a second contact surface positioned so as to be contacted by a protrusion during a rotation of the rod.

20. An apparatus for repelling burrowing animals comprising:
a rod adapted to be inserted into the ground, said rod having a longitudinal axis with a first portion oriented essentially vertically;
a vane mounted on said rod and adapted to rotate around the essentially vertically-oriented first portion of the rod;
a first strike member mounted on said rod; and
a second strike member mounted on said vane, said strike members being constructed and arranged to strike one another at least once for each fall rotation of said vane about said rod;
wherein a vibration corresponding to said strike is transmitted through the rod and into the ground.

21. The apparatus of claim 20, wherein the vane is adapted rotate uni-directionally irrespective of wind direction.

22. The device of claim 20, wherein the vane is shaped to blend into surrounding flora.

23. The device of claim 20, wherein rotational energy is provided by ambient wind.

24. The device of claim 20, wherein rotational energy is provided by a motor.
